(19) United States
(12) Patent Application Publication
(10) Pub. No.: US 2009/0312880 A1
(43) Pub. Date: Dec. 17, 2009

(54) SYSTEM AND METHOD FOR MONITORING AND CONTROLLING THE OPERATIONAL CONDITION OF A POWER TRANSFORMER

(76) Inventors: Luiz Américo Venturini Cheim, Itatiba Sao Paulo (BR); Jose Geraldo Gervino Silveira, Jundiai Sao Paulo (BR)

Correspondence Address: FAY SHARPE LLP, 1228 Euclid Avenue, 5th Floor, The Halle Building, Cleveland, OH, 44115, US

(21) Appl. No.: 11/993,579

(22) PCT Filed: Dec. 14, 2005
(86) PCT No.: PCT/BR05/00253

§ 371 Date: Jul. 2, 2008

(30) Foreign Application Priority Data
Jun. 21, 2005 (BR) PI0502384-0

(51) Int. Cl. G06F 1/28; G06F 11/07; G06Q 10/00; G06Q 50/00; G06F 3/048; G06F 17/30; G06N 5/02; G06F 15/16

(52) U.S. Cl. 700/292; 700/297; 714/57; 705/7; 715/771; 707/104.1; 706/46; 709/206

(57) ABSTRACT

The present invention refers to a system and method for monitoring and controlling the operational condition of a power transformer. The system for monitoring and controlling the operational condition of a power transformer comprised in a single substation comprising a control a control and data processing station linked to the transformers containing detection devices of the indicative signals of the measurements of operational parameters of the transformer; the signals being continuously detected by said devices; a user interface linked to said control station, the interface allowing a user to follow the measurements of the operational parameters of the transformer and determine ranges of desirable values of said operational parameters, said control station comprises a database that stores the data referring to the indicative signals of the measurements of the operational parameters of the transformer only when the measurements of the operational parameters differ from a range of operational parameter values previously defined as desirable. The method of the present invention comprises the steps of (a) continuously measuring operational parameters of a power transformer; and (b) storing the data referring to the measurements performed in step (a) only when said measurements are not within a range of previously determined as desirable for the measurements of said operational parameters.

This application claims priority of brazilin patent case No. PI0502384-0 filed on Jun. 21, 2005 which is hereby incorporated by reference.

The present invention refers to a system and method for monitoring and controlling the operational condition of several power transformers that are comprised at one single substation, which are able to detect failures in the operation of the transformers and to issue alerts indicating the occurrence of said failures. The system and method of the present invention may be employed in the follow up of all power transformers of a single substation, thus making the monitoring of the substation as a whole easier.

### DESCRIPTION OF THE STATE OF THE ART

The systems for monitoring and controlling the operational condition of a power transformer of the state of the art usually show the following architecture: a power transformer linked to a central control and data processing station, which, by its turn, is linked to an intranet environment. The transformer generally is provided with sensors that continuously detect measurements of parameters such as winding temperature, oil level, voltage, room temperature, tap, gases in oil, etc. The data referring to the measurements of these parameters may be accessed, followed, adjusted and monitored by a user through the intranet. The data are continuously stored in a database at the control substation.

The system disclosed above requires the database of the control substation to have a great storage capacity, because all the measurements detected by the sensors of the transformer are stored. Even though some of these measurements are not relevant, all of them are stored, and, consequently, fill the database with information that is little useful. Thus, the database of the system slowly becomes overloaded, slowing the system down.

Besides overloading the system, the continuous storage of all the data many times leads to a false diagnosis of the operational condition of the transformer. When the system detects an increase or decrease in the measurement of a parameter, it issues an alarm indicating the occurrence of a failure in the operation of the transformer. However, many times, these alarms are false, that is, they indicate a failure or a problem that in fact does not exist. The user may, for example, adjust a determined parameter for a different value of the one usually used for the transformer to operate at a specific condition during a determined time in order to comply with a specific demand. This minor adjustment may generate an expected variation in some other parameter. However, as the systems of the state of the art are not able to correlate these data, they issue a “false” alarm that the transformer is showing some problem. However, there is no problem in the operational condition of the transformer. These false alarms generate wrong diagnosis of the operational condition of the transformer. The person in charge of monitoring the transformer may be lead to believe that the transformer is showing a problem and take determined actions to solve the supposed problem without it existing in fact. The performance of determined procedures to overcome these supposed problems may, occasionally, generate actual failures in the system and harm or compromise the running of the transformer.

The system and method for monitoring and controlling the operational condition a power transformer proposed by the present invention come to overcome the above drawbacks and improve and ease the monitoring and control of the operational condition of transformers.

### OBJECTIVES OF THE INVENTION

The present invention aims at providing a system for monitoring and controlling the operational condition of a power transformer able to detect actual and, mostly initial, failures that may occur during the operation and running of a transformer, and, thus, give time for a user to act and correct said failure.

The present invention is further aimed at providing a system for monitoring and controlling the operational condition of a power transformer that continuously detects the measurements of parameters of the transformer, identifies when these measurements differ from values that were previously established as desirable for said parameters and stores this data in a database.

A third objective of the present invention consists in providing a system for monitoring and controlling the operational condition of a power transformer able to correlate data stored in a database in such a way as to avoid the emission of an alarm that suggests a failure or problem in the transformer that, in fact, does not exist. The alarms generated by systems to indicate a problem or failure in the operation or running of a transformer that, in fact, does not exist will be called herein below, false alarms.

The invention is further aimed at providing a system for monitoring and controlling the operational condition of a power transformer that may be accessed by a user anywhere in the world, preferably by means if an internet environment.

Another objective of the invention rests in providing a system for monitoring and controlling the operational condition of a transformer that comprises intelligent computational means that estimate the financial return generated due to the operation and running of a power transformer.

The invention is further aimed at providing a method for monitoring and controlling the operational condition of a transformer that continuously measures parameters of a power transformer and stores the data referring to the measurements only when said measurements are not within the range of values that were previously determined as desirable for the measurements of the respective parameters (intelligent storage).

The invention is further aimed at providing intelligent computational means that estimate the financial return generated due to the operation and running of a power transformer and that may be employed in different systems for monitoring and controlling the operational condition of a power transformer.

The invention is further aimed at providing a system and method for monitoring and controlling the operational condition of a power transformers that show an intelligent way for the acquisition and storage of data referring to the operation and running of the transformers.

### BRIEF DESCRIPTION OF THE INVENTION

The objectives of the present invention are reached by means of a system for monitoring and controlling the operational condition of a power transformers comprised at one single substation comprising a central control and data processing station linked to the transformers, containing devices for the detection of signals indicating the measurements of parameters of the transformer; the signals being continuously detected by said devices; an user interface linked to said control station, the interface allowing a user to follow the measurements of the parameters of the transformer and determine ranges of values that are desirable for said parameters, said control station comprising a database that stores the data referring to the indicative signals of the measurements of the parameters of the transformer only when the measurements of the parameters differ from a range of parameters values previously defined as desirable.

The invention additionally provides a method for monitoring and controlling the operational condition of a power transformer that comprises the steps of: (a) continuously measuring parameters of a power transformer; and (b) storing the data referring to the measurements performed in step (a) only when said measurements are not within a range of values that were previously determined as desirable for the measurements of said parameters.

### BRIEF DESCRIPTION OF THE DRAWINGS

The present invention will be, as follows, described in more detail based on an embodiment represented in the drawings. The figures show:

FIG. 1—illustrates the general architecture of the system for monitoring and controlling the operational condition of a transformer of the present invention;

FIGS. 2-13—illustrate several screenshots comprised in the system of the present invention showing different steps of the method for monitoring and controlling the operational condition of a power transformer of the present invention;

FIG. 14—illustrates a graph of the curves of a technical standard (in this case, ABNT—Brazilian Association of Technical Standards) relating the time of life expectancy (in years) of a transformer to the continuous Hot-Spot temperature (in ° C.).

### DETAILED DESCRIPTION OF THE INVENTION

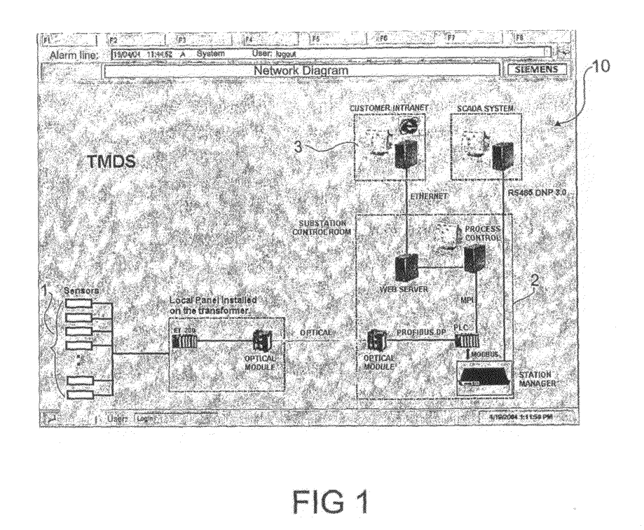

FIG. 1 illustrates a preferred general architecture of the system for monitoring and controlling the operational condition of a power transformer 10 of the present invention. As illustrated in this figure, the system 10 comprises a transformer provided with sensors 1, which are linked and communicate to a control station 2, which, by its turn, is linked to an internet environment 3.

The system for monitoring and controlling the operational condition of a power transformer 10 comprises a central control and data processing station (also called Process control or engineering server) 2 linked to a transformer that contains detection devices 1 for indicative signals of measurements of the parameters of the transformer. The signals are continuously detected by said devices 1 in order to provide a continuous monitoring of the transformer and, thus, better define the ways in which it behaves in different situations.

The system further comprises an user interface 3 linked to said control station 2 which allows that a user follows up the measurements of the parameters of the transformer and establishes ranges of desirable values for said parameters. The determination of these ranges of desirable values is of great importance, as it allows the system to take determined values as base for the monitoring and to be able to identify the occurrence of undesired variations in the parameters of the transformer. In order for the running and operation of a transformer to be optimized it is necessary that the parameters thereof show values within a specific range. The ranges of these values will be determined according to the criteria considered adequate by the companies which own the transformers and may vary.

The control station comprises a database that stores the data referring to the indicative signals of the measurements of the parameters of the transformer only when the measurements of the parameters differ from a range of values previously defined as desirable. Hence, if the measurements detected by the detection devices are not within the range of values defined as desirable for said parameter, the measurements will be stored in the database of the control station. If, on the other hand, the measured values are within the range of values determined as appropriate, these data will not be stored. That prevents the database from being filled with data with little relevance and optimizes the running of the system.

Some parameters may show small variations, however such variations may be relatively expected during the operation of a transformer, and, therefore, may not disclose or suggest any type of failure or problem in the transformer. However, it is important to have some kind of record of these variations, even though it should not be excessive.

Thus, the system displays previously defined storage ranges and failure ranges. The storage range determines a range of expected values for a determined parameter and determines a minimal delta that the detected variation should have in order to be stored. By its turn, the failure range determines a range of values that may be considered as indicative of a failure. For example, if a desired value for a determined parameter is 50 mu (measurement unity), the system may establish that values that show a minimal delta of 1 mu may be stored and values that show a minimal delta of 2 mu must be considered as indicative of an eventual failure. Hence, when the system detects 51 mu, this value will be stored, but will not indicate and neither will suggest any kind of failure in the system. However, when the system detects 52 mu, this value will be stored in the database and will indicate a possible failure in the transformer. However, the system will not issue any kind of alarm when the value of 52 is detected. Before issuing an alert, the central control and processing station (or engineering server) of the system will correlate this variation with the remaining measured values and analyze if that variation in fact indicates or not some kind of failure in the transformer.

Thus, when the measured value of a parameter is not comprised within the range previously determined as desirable (storage range) and, further, fits within the range of values that may be considered as indicative of failure (failure range), the systems performs a correlation with the remaining measurements in order to identify if the variation happened due to the establishment of a new range of values for another parameter or if such variation is due to a specific situation at a determined moment. With the correlation of these information and data, the system itself can evaluate if in fact there is any failure or problem in the transformer. If the analysis performed by the system does not identify any failure, no alarm will be issued. The emission of false alarms is thus prevented.

On the other hand, if the system identifies any failure or problem in the transformer, the system will generate a diagnosis of the operational condition and, if applicable, suggest a recommended action and indicate the consequences that may happen if the recommended action is not taken.

One of the main aspects of the present invention consists, therefore, in the fact that only some of the measurements of the parameters of the transformers are stored in the database. Thus, the database is less full of information and the utilization of the system becomes faster and quicker. The intelligence of the systems allows an optimization in the data acquisition and storage.

Preferably, the system for monitoring and controlling the operational condition of a power transformer of the present invention further comprises a data processing and management module of the data stored at the database. This module will be responsible for the correlation of the stored data by the evaluation of the correlation between said stored data and by the generation of a diagnosis of the operational condition of the transformer. If applicable, the processing and management module will suggest a recommended action to correct the failure or problem of the transformer and will indicate the consequences that may happen if the recommended action is not taken. The processing and management module basically comprises a processor.

Another important aspect of the invention lies in the fact that all stored data may serve to generate a history of the behavior and of the operational conditions of a power transformer during a determined period of time. From the information stored at the database reports may be generated with this history, allowing a user to have a general view of the operation of a transformer.

The user interface and the control station must, preferably, be developed in an internet environment, in such a way as to allow a user to have remote access to the monitoring and controlling system of the invention. Working on an internet environment, the access and follow up of the operation of a transformer is possible from anywhere in the world. All information, data, alarms and diagnosis remain available in the intranet/internet of the user.

The parameters of the transformer which are continuously measured refer to at least one among winding temperature, oil level, voltage, room temperature, tap, gases in oil, oil humidity, air flow, oil upper/lower temperatures and insulation conditions. Any other parameters may be measured and are not limited to those exemplified above.

The invention also foresees the possibility of the control station to comprise an electronic mail device that sends an e-mail to a user when a failure in the operational condition of the transformer is detected. The companies define which persons must receive the alert e-mails. The sending of e-mails makes the follow-up and monitoring of the transformers and of the substation as a whole easier. With the sending of alert e-mails, the person in charge of the monitoring is not required to check all the time if any failure happened in the system. That reduces, therefore, the need for a large number of people to monitor a substation with many transformers. Thus, companies may have a reduction in the number of people for the performance of this function (monitoring of the transformers) and reduce costs.

The e-mail sent to the person in charge of monitoring the transformers indicates an internet address that must be accessed to verify the problem. Several people may be registered in the system to receive the alert e-mails. However, as soon as one of the registered user accesses the internet site indicated in the alert e-mail, a new e-mail is sent to the other registered users informing that the problem is being verified by the user that accessed the site. Thus, all registered users are notified that a failure is taking place in the system and that a determined user is arranging the solution for said failure.

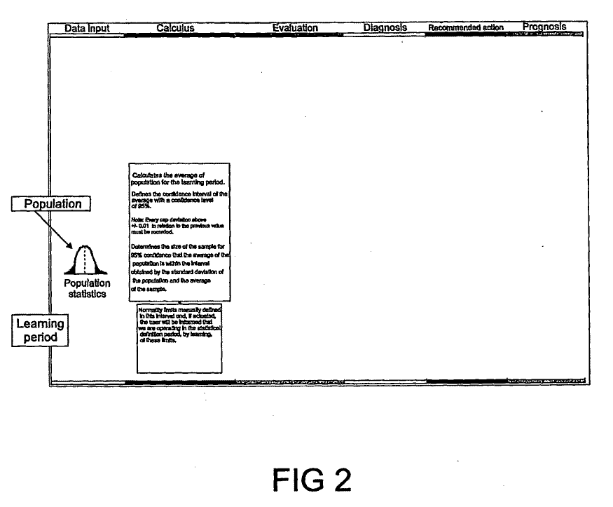

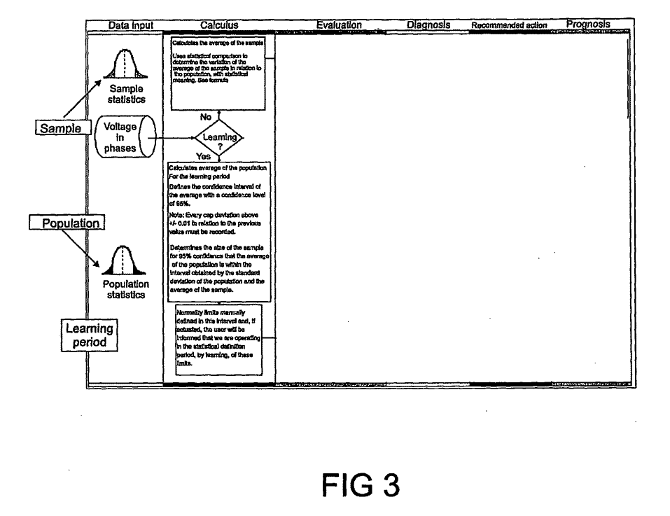

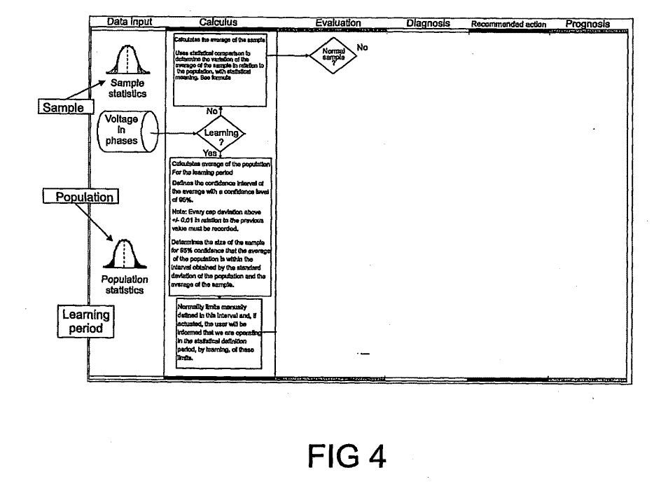

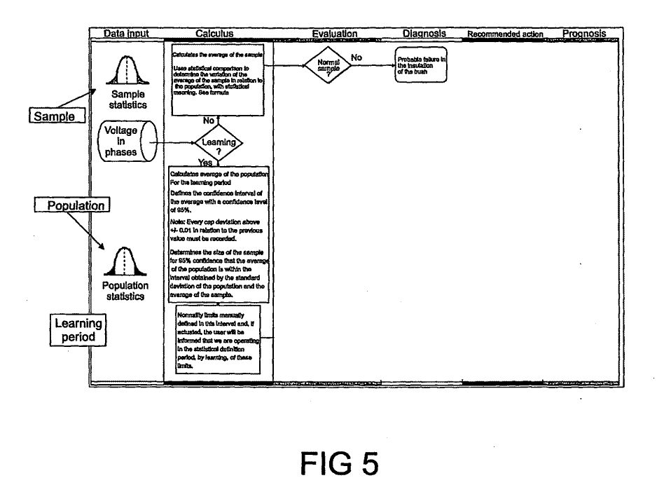

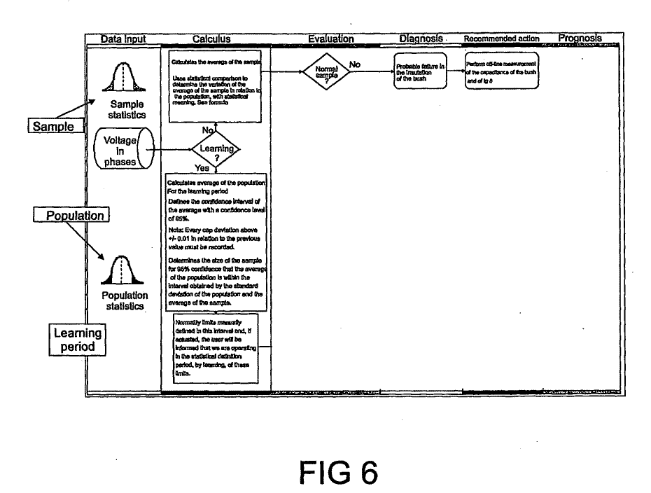

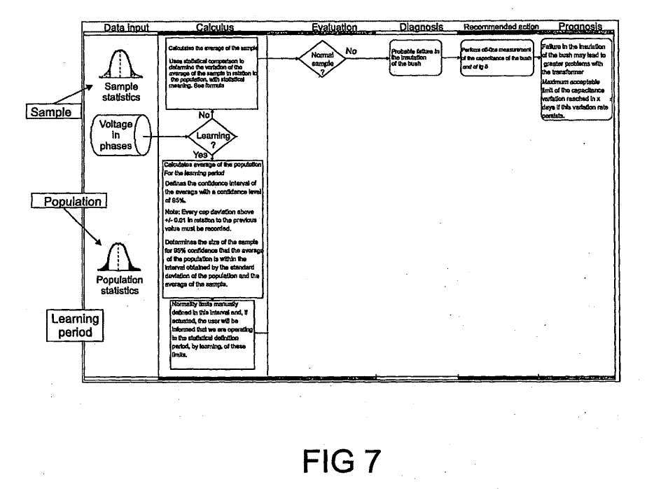

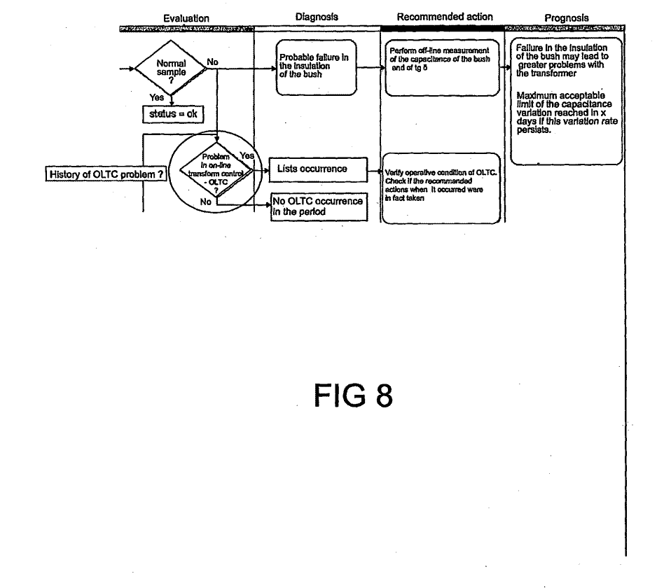

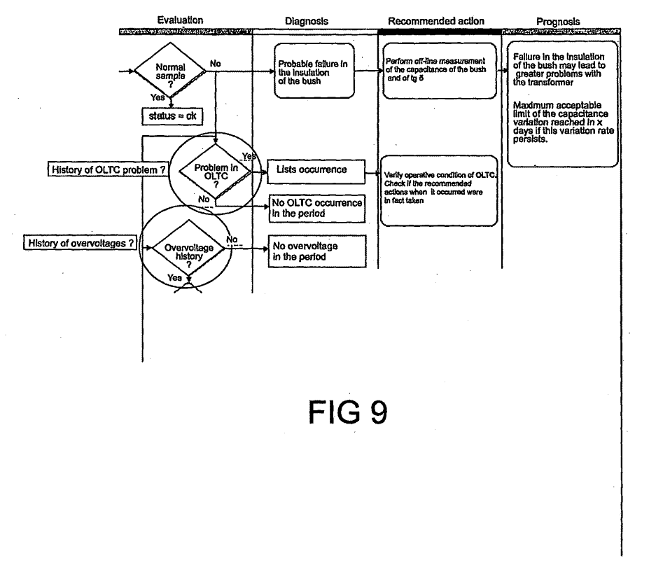

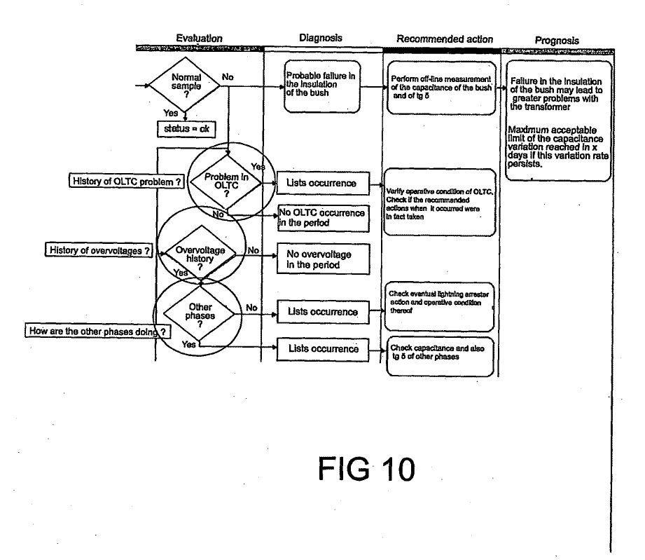

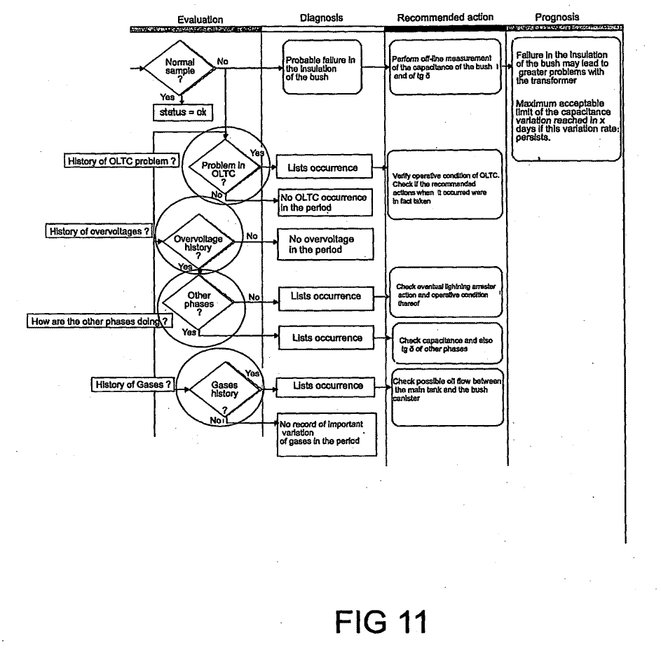

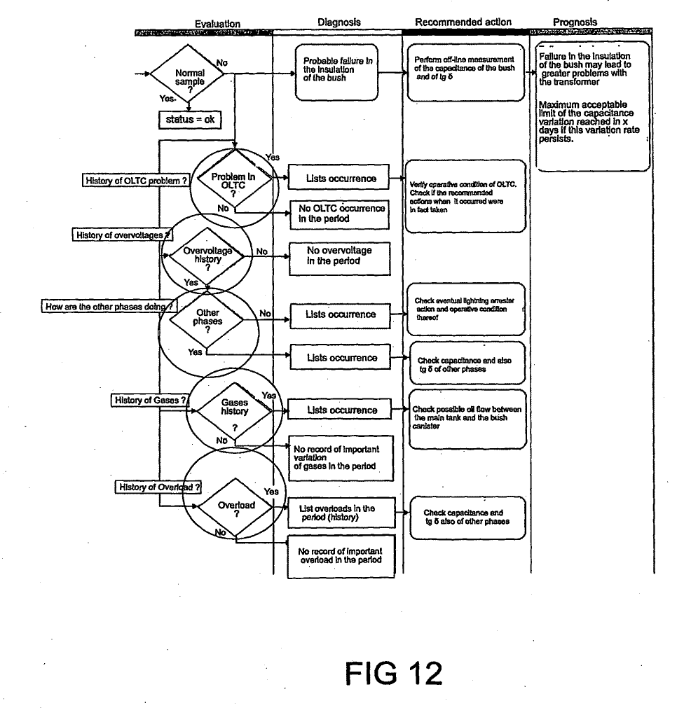

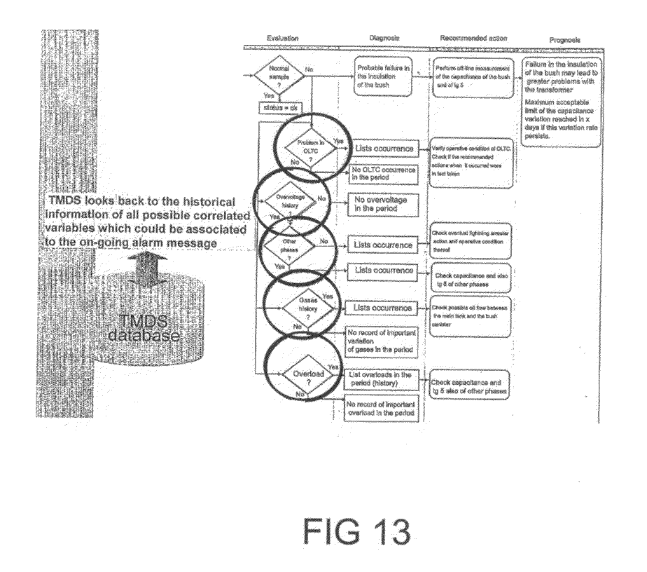

Referring to FIGS. 2 to 13, there are illustrated screenshots exemplifying the system for monitoring and controlling the operational condition of a transformer, showing step by step the steps of data input, calculus, evaluation, diagnosis, recommended action and prognosis.

The system of the present invention optionally comprises computational means (for example, software) that generate an analysis of the financial return from the use of the transformer using a mathematical equation or economic profitability calculation of a power transformer.

The computational means represent a technical-economical model that is based on the fundamental issue regarding the life expectancy of a transformer. According to Brazilian (ABNT) and international (IEEE-ANSI/USA—The Institute of Electrical and Electronics Engineers, Incorporated/American National Standards Institute, IEC—International Engineering Consortium and other countries of the world) technical standards, it can be understood that the life expectancy of a transformer is associated to the equivalent operation temperature at the hot spot that is monitored. For example, if a transformer operates at 95° C. at the hot spot, it is expected to last 35 to 40 years, depending on the standard. If it is wanted that a transformer lasts 40 yeas, according to ABNT, the transformer will have to operate with an equivalent temperature of 95° C. Although it may seem simple, this analysis is very complex, principally because the temperature at the hot spot of the transformer is not continuously monitored and, in general, it is not known what this equivalent temperature would be along 5 or 10 years of operation, even because this temperature varies cyclically with load (for example, the load in summer is different from the load in winter) and with the room temperature itself.

Under a financial point of view, it must be further analyzed what is the economic impact associated to the type of operation to which the transformer is subjected. For example, in Brazil, ANEEL (National Agency of Electrical Energy) determines that the transformer must last 40 years. The electric power utility company must perform an investment to acquire the transformer, keep it along these forty years, depreciate the invested capital, pay interest over the loan made to acquire the asset, run an operational risk (for example, of not meeting the demand in case of failure of the equipment) and, additionally, have some kind of financial return for the fact of meeting the power demand when it installs the transformer at some substation or electrical power plant.

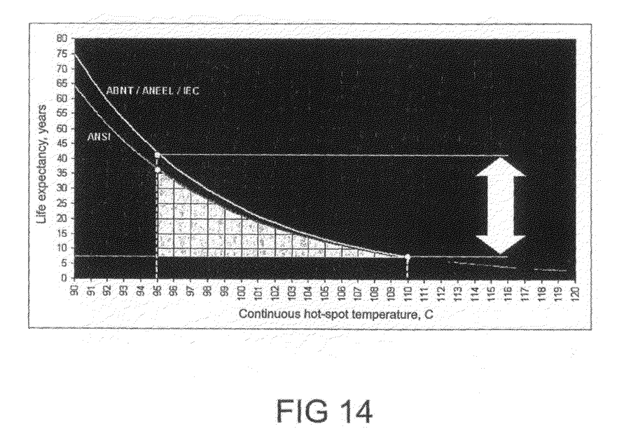

This technical-economical model mentioned aims at associating all these parameters, including life expectancy of the equipment, the financial return that the company would have if the equipment lasted 40 years or 10 years, for example. All this, based on the simple accounting equation shown as follows, in the curves of the standard illustrated in FIG. 14 relating the depreciation time (or equipment life), to the costs involve din the acquisition/operation thereof and of meeting the demand for power.

Result=Revenue−TOC(Total Cost of Ownership) (Equation 1)

Where:

TOC=annual depreciation+annual maintenance cost+annual insurance cost+opportunity cost+monetary devaluation cost+failure risk.

Revenue=net remuneration by meeting the demand of power×load factor of the transformer (how much per cent of the nominal capacity is used to meet the demand, limited to the value that leads to the life expectancy calculated as per the curves of the standard shown in FIG. 15)×monetary correction factor×factor of transformer use (how long of the 24 h×365 days of the year the transformer, in average, is kept in fact energized)×efficiency of the transformer (part of the power that the transformer receives is lost internally so that it operates adequately and gives to at the other end the desired level of voltage, at the desired power)+net remuneration by meeting the power demand×load factor of the transformer (how much per cent of the nominal capacity is used to meet the demand, limited to the value that leads to the life expectancy calculated as per the curves of the standard shown in FIG. 15)×monetary correction factor×factor of transformer use (how long of the 24 h×365 days of the year the transformer, in average, keeps in fact energized)×efficiency of the transformer (part of the power that the transformer receives is lost internally so that it operates adequately and gives to at the other end the desired level of voltage, at the desired power)×factor of overload remuneration (how much more the power utility company receives by meeting the peaks of electrical power demand, above the nominal conditions of the equipment)×average time of overload in the year.

Failure risk=failure cost×probability of failure (Eq. 2)

Probability=1−reliability (Eq. 3)

Reliability=e^{-λ×t} (Eq. 4)

Risk=failure cost×(1−e^{-λ×t}) (Eq. 5)

Where:

λ=average accumulated rate of failure of the transformers (typically of about 1.5 to 3% per year).

t=time of operation in years.

Failure cost:

a) Conservative: cost of replacing the failed transformer by a new one;

b) Aggressive: same as item a) obeying costs of not meeting the demand and to the costs involved in the acquisition/operation of the equipment.

The failure cost is defined as an annual “cost”, associated to the failure probability that also grows annually in this model, even considering a failure rate constant to the power utility company (factor A in the expression above).

The annual cost is then defined by the failure probably (1−reliability)×failure cost, which conservatively is considered the same as the cost of replacing a failed unity by a new one. All this is considered year by year.

The present mathematical model demonstrates that not always the higher financial return happens when the life time of the transformer is of about 40 years, as ABNT suggests. In some cases, the model demonstrates that it is more advantageous under an economical and financial point of view to operate the transformer with a higher load for a shorter period of time (for example, of about 15 years). The mathematical model brings innovative results, surprising in relation to the best way of operating a transformer to achieve the highest financial return.

The present invention further provides a method for the monitoring and controlling the operational condition of a power transformer, which comprises the steps of: (a) continuously measuring parameters of a power transformer; and (b) storing the data referring to the performed measurements in step (a) only when said measurements are not within a range of values previously defined as desirable for the measurements of said parameters.

Preferably, the method further comprises the steps of (c) correlating said stored data; (d) evaluating the correlation made between said stored data; (e) generating a diagnosis of the operational condition of the transformer based on the evaluation made in step (d) and, if applicable, suggesting a recommended action and indicating the consequences that may happen if the recommended action is not taken.

The method comprises the additional step of sending an e-mail to a user when a failure in the operational condition of the transformer is detected, indicating and internet address (website) that must be accessed by the user in order to verify the problem.

The method is preferably performed by a system for monitoring and controlling the operational condition of a power transformer system of the invention.

For effects of the present invention, it must be understood as a control station any control station commonly found in the state of the art, but that comprises devices and equipments such as to allow that only relevant variation measured by the detection devices are stored in a database. The control station of the present invention is an intelligent station that can distinguish the relevance of different variations in the measurements of the parameters of the transformer, determining thus which measurements must be stored in the database and which should not be stored. It must be stressed that only measurements that are not comprised within a range of values previously determined as desirable must be stored.

Furthermore, it is important to be understood that the user may, remotely, adjust and establish new ranges of desirable values for the parameters of a transformer according to different criteria.

The detection devices of the indicative signals of the measurements of the parameters of the transformer may be any of those usually used in the state of the art, for example, sensors.

A preferred embodiment having been disclosed, it must be understood that the scope of the present invention encompasses other possible variations, being limited only by the content of the appended claims, possible equivalents also included.

1. System for monitoring and controlling the operational condition of power transformers comprised at a single substation comprising:
a control and data processing station linked to the transformers containing detection devices of indicative signals of the measurements of operational parameters of the transformer; the signals being continuously detected by said devices;
wherein said control station comprises:
a user interface linked to said control station, the interface exhibiting the measurements of the operational parameters of the transformer and allowing the user to input determined s ranges of desirable values of said operational parameters,
a database that stores the data referring to the indicative signals of the measurements of the operational parameters of the transformer only when the measurements of the operational parameters differ from a range of operational parameter values previously defined as desirable.

2. System for monitoring and controlling the operational condition of power transformer, according to claim 1, wherein the central control station further comprises:
a data processing and management module of the data stored at the database that correlates the stored data, evaluates the correlation between said stored data and generates a diagnosis of the operational condition of the transformer, and, if applicable, suggests a recommended action and indicates the consequences that may happen if the recommended action is not taken.

3. System according to claim 1, wherein the operational parameters of the transformer refer to at least one among winding temperature, oil level, voltage, room temperature, tap, gases in oil, oil humidity, air flow, oil upper/lower temperatures, and insulation conditions.

4. System according to claim 1, wherein the control station is developed in internet environment.

5. System according to claim 1, wherein said system may be remotely accessed by a user.

6. System according to claim 1, further comprising software that generates an analysis of the financial return proceeding from the use of the transformer using the following mathematical equation: Failure risk=failure cost×probability of failure (Equation 1).

7. System according to claim 1, wherein the control station further comprises an electronic mail device that sends an e-mail to a user when a failure in the operational condition of the transformer is detected.

8. Method for monitoring and controlling the operational condition of a power transformer, said method comprising the steps of:
(a) continuously measuring operational parameters of a power transformer; and
(b) storing the data referring to the measurements performed in step (a) only when said measurements are not within a range of values previously determined as desirable for the measurements of said operational parameters.

9. Method for monitoring and controlling the operational condition of a power transformer, according to claim 8, further comprising the steps of:
(c) correlating said stored data;
(d) evaluating the correlation made between said stored data;
(e) generating a diagnosis of the operational condition of the transformer based on the evaluation made in step (d) and, if applicable, suggesting a recommended action and indicating the consequences that may occur if the recommended action is not taken.

10. Method according to claim 8, wherein said method is performed by a system for monitoring and controlling the operational condition of power transformers comprised at a single substation, the system comprising:
a control and data processing station linked to the transformers containing detection devices of indicative signals of the measurements of operational parameters of the transformer; the signals being continuously detected by said devices;
wherein said control station comprises:
a user interface linked to said control station, the interface exhibiting the measurements of the operational parameters of the transformer and allowing the user to input determined ranges of desirable values of said operational parameters,
a database that stores the data referring to the indicative signals of the measurements of the operational parameters of the transformer only when the measurements of the operational parameters differ from a range of operational parameter values previously defined as desirable

11. Method according to claim 8, further comprising the step of sending an e-mail to a user when a failure in the operational condition of the transformer is detected.

12. System according to claim 2, wherein the operational parameters of the transformer refer to at least one among winding temperature, oil level, voltage, room temperature, tap, gases in oil, oil humidity, air flow, oil upper/lower temperatures, and insulation conditions.

13. System according to claim 2, wherein the control station is developed in internet environment.

14. System according to claim 3, wherein the control station is developed in internet environment.

15. System according to claim 2, wherein said system may be remotely accessed by a user.

16. System according to claim 3, wherein said system may be remotely accessed by a user.

17. System according to claim 4, wherein said system may be remotely accessed by a user.

18. System according to claim 2, further comprising software that generates an analysis of the financial return proceeding from the use of the transformer using the following mathematical equation: Failure risk=failure cost×probability of failure (Equation 1).

19. System according to claim 3, further comprising software that generates an analysis of the financial return proceeding from the use of the transformer using the following mathematical equation: Failure risk=failure cost×probability of failure (Equation 1).

20. System according to claim 4, further comprising software that generates an analysis of the financial return proceeding from the use of the transformer using the following mathematical equation: Failure risk=failure cost×probability of failure (Equation 1).
